(19) United States
(12) Patent Application Publication
(10) Pub. No.: US 2022/0245746 A1
(43) Pub. Date: Aug. 4, 2022

(54) NETWORKED COMPUTER SYSTEM FOR RAPID IDENTIFICATION OF RELATED ASSETS AND COMMENT GENERATION THEREFOR

(71) Applicant: Sony Interactive Entertainment LLC, San Mateo, CA (US)

(72) Inventors: Gary Zalewski, San Mateo, CA (US); Cromwell Ortiz, San Mateo, CA (US); Foley Laiyemo, San Mateo, CA (US)

(21) Appl. No.: 17/590,639

(22) Filed: Feb. 1, 2022

Related U.S. Application Data
(60) Provisional application No. 63/159,374, filed on Mar. 10, 2021.
(60) Provisional application No. 63/144,084, filed on Feb. 1, 2021.

(51) Int. Cl. G06Q 50/18; G06F 16/383; G06F 40/169; G06F 40/258

(52) U.S. Cl. CPC G06Q 50/184; G06F 40/258; G06F 40/169; G06F 16/383

(57) ABSTRACT

A networked computer system includes an architecture for rapid identification of related assets including by the use of keyword searches from bullet dates. Comments may be appended to reports based on trigger-based rules.

### FIELD

The present application relates to technically inventive, non-routine solutions that are necessarily rooted in computer technology and that produce concrete technical improvements.

### BACKGROUND

As understood herein, assets such as patent applications can have numerous co-relationships that are not always simple to track and identify.

### SUMMARY

Accordingly, a method for creating a family of related records with common data in a memory device of at least one server includes causing, by the server, display of an object on a user device via a computer network. The method also includes obtaining, by the server, data for at least one current filing. At least a portion of the data is entered into the object. The data is communicated to the server via the computer network. Further, the method includes creating, by the server, a record in the memory device of the server for the current filing based on the obtained data, and causing, by the server, display of a user interface (UI) object on the user device via the computer network. The UI object includes a parent title. The method further obtains, by the server, data for one or more related filings associated with the parent title. The data includes record links between the current filing and the one or more related filings that indicate that the current filing and the related filings belong to a family of intellectual assets.

Still further, the method may include identifying, by the server, relationships between the current filing and the related filings. Each of the relationships includes one or more of a parent/child relationship, a foreign/domestic relationship, a continuation/parent relationship, a continuation-in-part/parent relationship, a nationalization relationship, a PCT/nationalization relationship, a PCT/priority relationship, or a provisional/non-provisional relationship.

The method may include determining respective statuses for the current filing and related filings, receiving a bullet date, identifying changes in the statuses since the bullet date, and outputting a report highlighting the changes since the bullet date. The method includes automatically adding to the report at least one comment responsive to a rule associated with the comment being triggered.

In some examples the changes in statuses include changes as of the bullet date.

In an example, the UI object can include one or more of inventor information correlated with the parent title, docket information correlated with the parent title, country information correlated with the parent title, sub-case information correlated with the parent title, application number information correlated with the parent title, filing date information correlated with the parent title, status information correlated with the parent title, patent date information correlated with the parent title, and patent number information correlated with the parent title.

If desired, the method can include automatically adding to the report at least one comment responsive to a rule associated with the comment being triggered.

In another aspect, an apparatus includes at least one processor programmed with instructions for searching related intellectual asset (IA) records with data in a memory device of an intellectual asset management (IAM) server. The processor is programmed to obtain, by the IAM server, keywords, enter the keywords into an IA template object accessible from the IAM server via the computer network, and cause, by the IAM server, display of a template user interface (UI) on a user device consistent with the IA template. The template UI presents selectors corresponding to respective keywords. The processor is further programmed to receive, from the user device, one or more selections of the selectors corresponding to respective keywords. The processor is programmed to search using at least one computer a corpus of documents using the keywords corresponding to the selections from the user device, return documents from the corpus according to matching criteria of the keywords, and present on the user device a results UI listing documents returned according to the matching criteria. This results UI includes information indicating, for each keyword matched in a first document, a frequency of match of the respective keyword.

In another aspect, an apparatus includes at least one computer storage that is not a transitory signal and that comprises instructions executable by at least one processor for:

causing, by a server, display of an object on a user device via a computer network;

obtaining data for at least one current filing, at least a portion of the data being entered into the object, the data being communicated to the server via the computer network;

creating a record in the memory device of the server for the current filing based on the obtained data;

displaying a user interface (UI) on the user device via the computer network, the UI including a parent title;

obtaining data for one or more related filings associated with the parent title, wherein the data includes record links between the current filing and the one or more related filings that indicate that the current filing and the related filings belong to a family of intellectual assets;

identifying relationships between the current filing and the related filings, each of the relationships including one or more of a parent/child relationship, a foreign/domestic relationship, a continuation/parent relationship, a continuation-in-part/parent relationship, a nationalization relationship, a PCT/nationalization relationship, a PCT/priority relationship, or a provisional/non-provisional relationship;

determining respective statuses for the current filing and related filings;

receiving a bullet date;

identifying changes in the statuses since the bullet date; and

outputting a report highlighting the changes since the bullet date.

The instructions may be executable for automatically adding to the report at least one comment responsive to a rule associated with the comment being triggered.

In another aspect, a computer-implemented method includes generating a document record report and identifying at least one trigger event associated with document records reflected in the document record report. The method also includes identifying at least one comment associated with the trigger event, adding to the comment at least one computation result related to the trigger event, and appending the comment to the document record report.

In some examples the method may include, responsive to the trigger event, identifying whether a trigger criteria is met. The method may further include identifying at least one rule associated with the trigger criteria. The rule is associated with the comment, and the computation result is based at least in part on the trigger criteria.

Without limitation, the trigger event may include one or more of a document filing, an elapse of a time period, and a request for a report.

The method may include appending to the document record report no more than “N” comments based on a priority of rules that may be static or not static (dynamic).

In another aspect, a device includes at least one computer memory that is not a transitory signal and that in turn includes instructions executable by at least one processor to generate a document record report. The instructions are executable to identify at least one trigger event associated with document records reflected in the document record report, identify at least one comment associated with the trigger event, and add to the comment at least one computation result related to the trigger event. The instructions are executable to append the comment to the document record report.

In an aspect, a method for creating a family of related records with common data in a memory device of at least one server includes causing, by the server, display of an object on a user device via a computer network. The method also includes obtaining, by the server, data for at least one current filing. At least a portion of the data is entered into the object. The data is communicated to the server via the computer network. Further, the method includes creating, by the server, a record in the memory device of the server for the current filing based on the obtained data, and causing, by the server, display of a user interface (UI) object on the user device via the computer network. The UI object includes a parent title. The method further obtains, by the server, data for one or more related filings associated with the parent title. The data includes record links between the current filing and the one or more related filings that indicate that the current filing and the related filings belong to a family of intellectual assets.

Still further, the method may include identifying, by the server, relationships between the current filing and the related filings. Each of the relationships includes one or more of a parent/child relationship, a foreign/domestic relationship, a continuation/parent relationship, a continuation-in-part/parent relationship, a nationalization relationship, a PCT/nationalization relationship, a PCT/priority relationship, or a provisional/non-provisional relationship.

The method may include determining respective statuses for the current filing and related filings, receiving a bullet date, identifying changes in the statuses since the bullet date, and outputting a report highlighting the changes since the bullet date.

In some examples the changes in statuses include changes as of the bullet date.

In an example, the UI object can include one or more of inventor information correlated with the parent title, docket information correlated with the parent title, country information correlated with the parent title, sub-case information correlated with the parent title, application number information correlated with the parent title, filing date information correlated with the parent title, status information correlated with the parent title, patent date information correlated with the parent title, and patent number information correlated with the parent title.

In another aspect, a method for searching related intellectual asset (IA) records with data in a memory device of an intellectual asset management (IAM) server includes obtaining, by the IAM server, keywords and entering the keywords into an IA template object. The IA template object is accessible from the IAM server via the computer network. The method includes causing, by the IAM server, display of a template user interface (UI) on a user device consistent with the IA template. The template UI can present selectors corresponding to respective keywords. The method may include receiving, from the user device, one or more selections of the selectors corresponding to respective keywords and searching using at least one computer a corpus of documents using the keywords corresponding to the selections from the user device. Documents from the corpus are returned according to matching criteria of the keywords, and a results UI is presented listing documents returned according to the matching criteria. The results UI may include information indicating, for each keyword matched in a first document, a frequency of match of the respective keyword.

In another aspect, a device includes at least one computer memory that is not a transitory signal and that in turn includes instructions executable by at least one processor to implement (A), or (B), or both (A) and (B). (A) includes causing by the server, display of an object on a user device via a computer network, obtaining, by the server, data for at least one current filing, at least a portion of the data being entered into the object, the data being communicated to the server via the computer network, creating, by the server, a record in the memory device of the server for the current filing based on the obtained data, causing, by the server, display of a user interface (UI) object on the user device via the computer network, the UI object including a parent title, further obtaining, by the server, data for one or more related filings associated with the parent title, wherein the data includes record links between the current filing and the one or more related filings that indicate that the current filing and the related filings belong to a family of intellectual assets, identifying, by the server, relationships between the current filing and the related filings, each of the relationships including one or more of a parent/child relationship, a foreign/domestic relationship, a continuation/parent relationship, a continuation-in-part/parent relationship, a nationalization relationship, a PCT/nationalization relationship, a PCT/priority relationship, or a provisional/non-provisional relationship, and determining respective statuses for the current filing and related filings;

On the other hand, (B) includes obtaining, by the server, keywords, entering the keywords into a template object accessible from the server via the computer network, causing, by the server, display of a template user interface (UI) on a user device consistent with the template, the template UI presenting selectors corresponding to respective keywords, receiving, from the user device, one or more selections of the selectors corresponding to respective keywords, searching using at least one computer a corpus of documents using the keywords corresponding to the selections from the user device, returning documents from the corpus according to matching criteria of the keywords, and presenting on the user device a results UI listing documents returned according to the matching criteria, the results UI comprising information indicating, for each keyword matched in a first document, a frequency of match of the respective keyword.

The details of the present application, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example system including an example in accordance with present principles;

FIG. 2 illustrates an example system consistent with present principles;

FIG. 3 illustrates an example user interface (UI) consistent with present principles;

FIGS. 4 and 5 illustrate example logic in example flow chart format consistent with present principles;

FIGS. 6 and 7 illustrate further example UIs consistent with present principles;

FIG. 8 illustrates example logic in example flow chart format consistent with present principles related o adding sentences to reports based on rule triggers;

FIG. 9 illustrates an example data structure consistent with FIG. 8; and

FIG. 10 illustrates an example UI consistent with FIG. 8.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website to network members.

A processor may be a single- or multi-chip processor that can execute logic by means of various lines such as address lines, data lines, and control lines and registers and shift registers.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

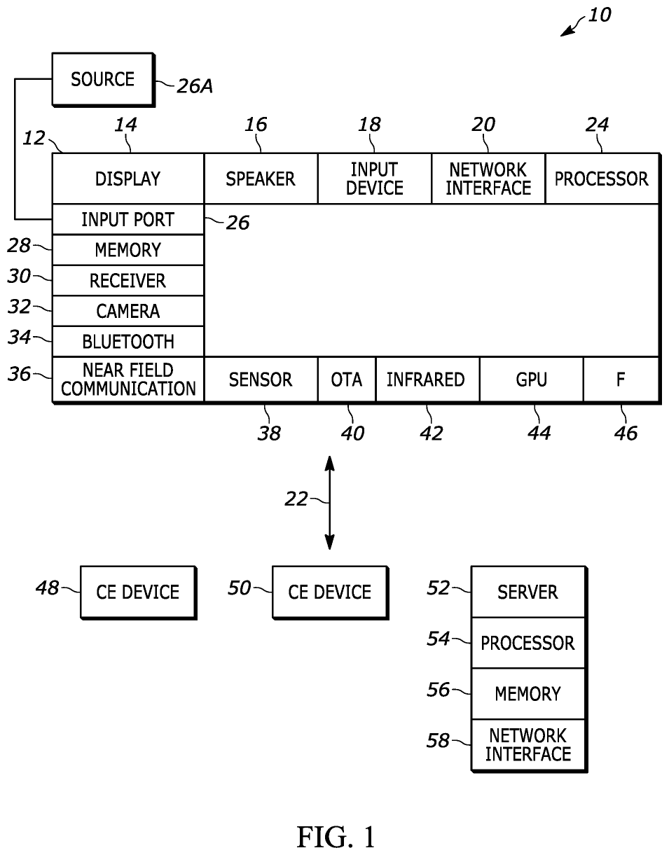

Now specifically referring to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to an Internet-enabled TV with a TV tuner (equivalently, set top box controlling a TV). The AVD 12 alternatively may also be a computerized Internet enabled (“smart”) telephone, a tablet computer, a notebook computer, a HMD, a wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown in FIG. 1. For example, the AVD 12 can include one or more displays 14 that may be implemented by a high definition or ultra-high definition “4K” or higher flat screen and that may be touch-enabled for receiving user input signals via touches on the display. The AVD 12 may include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. A graphics processor may also be included. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input ports 26 such as a high-definition multimedia interface (HDMI) port or a USB port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 44.

The AVD 12 may further include one or more computer memories 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24. The component 30 may also be implemented by an inertial measurement unit (IMU) that typically includes a combination of accelerometers, gyroscopes, and magnetometers to determine the location and orientation of the AVD 12 in three dimensions.

Continuing the description of the AVD 12, in some embodiments the AVD 12 may include one or more cameras 32 that may be a thermal imaging camera, a digital camera such as a webcam, and/or a camera integrated into the AVD 12 and controllable by the processor 24 to gather pictures/images and/or video in accordance with present principles. Also included on the AVD 12 may be a Bluetooth transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 (e.g., a motion sensor such as an accelerometer, gyroscope, cyclometer, or a magnetic sensor, an infrared (IR) sensor, an optical sensor, a speed and/or cadence sensor, a gesture sensor (e.g., for sensing gesture command), providing input to the processor 24. The AVD 12 may include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included.

Still referring to FIG. 1, in addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other devices of FIG. 1 over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown in FIG. 1 or nearby.

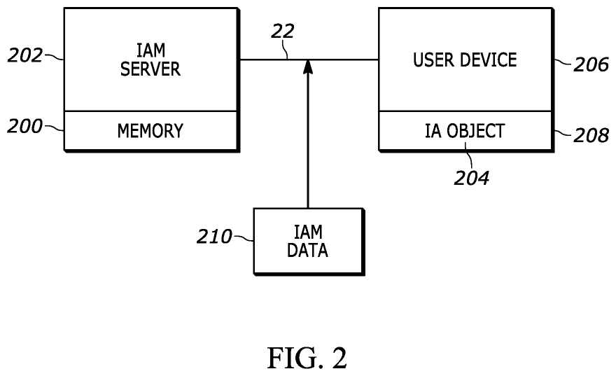

The components shown in FIG. 2 may include some or all components shown in FIG. 1.

FIG. 2 illustrates a system for creating a family of related intellectual asset (IA) records with common data in a memory device 200 of an intellectual asset management (IAM) server 202, which may include some or all of the appropriate components from relevant devices in FIG. 1. The server 202 can send an IA object 204 such as a user interface (UI) to one or more user devices 206 via the computer network 22 for presentation of the UI on a display 208 of the user device 206, which may be implemented by any of the computerized devices described herein.

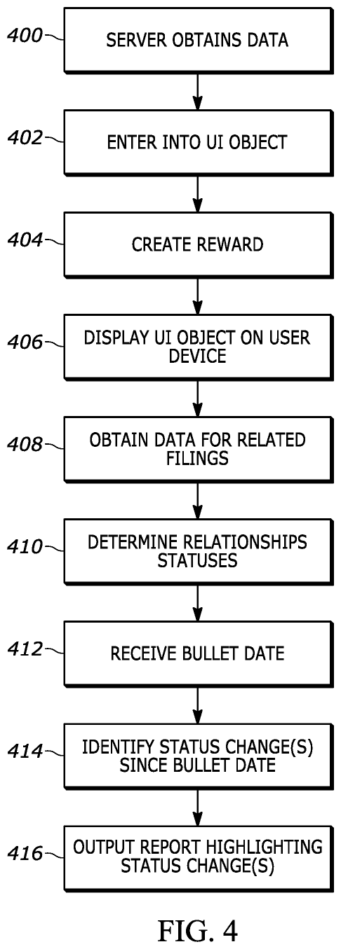

As indicated at block 400 in FIG. 4 and as illustrated in FIG. 2, the server 202 obtains IA data 210 from, e.g., a database or computer network or other source for at least one current filing, typically for plural patent and/or trademark and/or copyright filings. The IA data is entered into the UI object 204 at block 402 for presentation thereof on the user device.

Moving to block 404, the IAM server creates an IA record in the memory device 200 of the IAM server 204 for the one or more currents filing based on the obtained IA data 210. The IAM server at block 406 may cause display of the UI object 204, in this case, an IA priority UI object, on the user device 206 via the computer network 22. Moving to block 408, the server obtains further IA data for one or more related filings associated with a parent title of the current filing. This IA data can include IA record links between the current filing and the one or more related filings that indicate that the current filing and the related filings belong to a family of intellectual assets.

Proceeding to block 410, the IAM server determines relationships between the current filing and the related filings. For example, these relationships may include a parent/child relationship, a foreign/domestic relationship, a continuation/parent relationship, a continuation-in-part/parent relationship, a nationalization relationship, a PCT/nationalization relationship, a PCT/priority relationship, or a provisional/non-provisional relationship.

The server also identifies statuses for the current filing and related filings. For example, these statuses include pending, abandoned, allowed, issued, and the like.

Moving to block 412, a bullet date is received from the user device 206. The bullet date may be a date from which it is desired to know changes in status. For example, if due diligence on an acquisition began on July 1, and the acquisition closes on August 1, the bullet date may be July 1 and may be input on August 1.

Accordingly, block 414 indicates that changes in the statuses since the bullet date to, e.g., the current date can be identified. A report may be output at block 416 highlighting status changes.

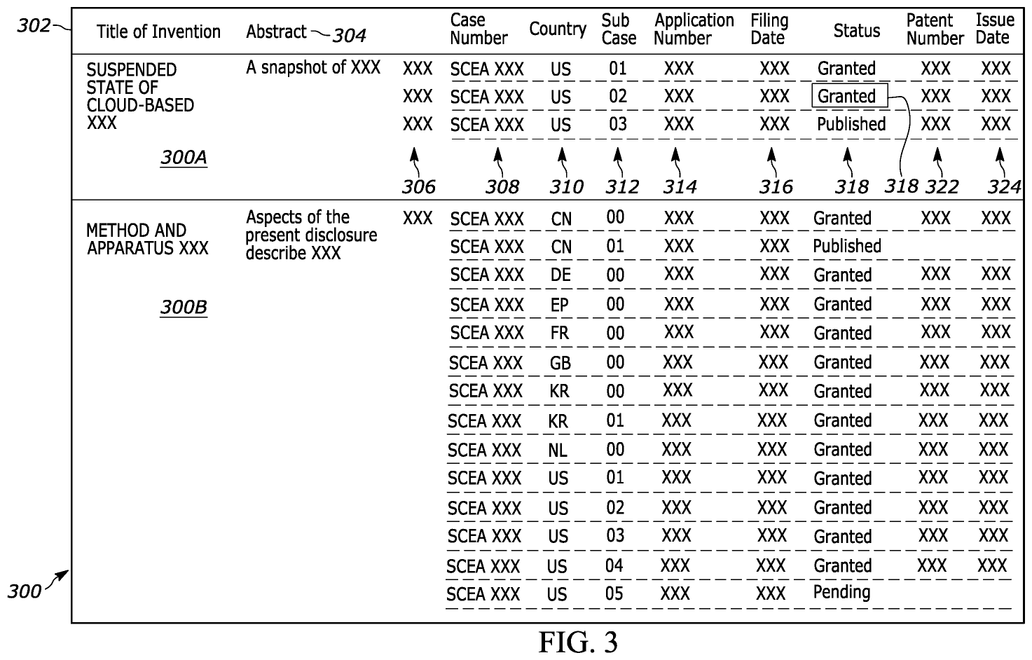

FIG. 3 illustrates further, showing two entries 300A, 300B for two patent asset families. Note that for each family or “title” 300A, 300B there is clean and clear alignment of fields. Note that the vertical real estate of multiple lines occupied by the contents of the abstract allows for multiple lines of national phase case detail for the case reference.

An example UI object 300 consistent with disclosure herein may include a title column 302 with titles associated with respective IA assets. An abstract column 304 may include abstracts for each respective asset. After the Title and abstract are “case details”, which may be any combination of fields shown or custom fields. In general, case details will always include patent family members for the Title case. Note the vertical space between the first title 300A and second title 300B, rendering the family case detail for the first title 300A clear and not confounded with data from the second title 300B.

In the example shown, the case details include, next to the abstract column 304, an inventor column 306 that may list inventors or authors of the respective IA assets.

Each asset may be accorded a docket number that can be listed in a docket column 308. Also, each asset may be associated with a national filing the country for which can be indicated in a column 310.

Further, each asset may be accorded a sub-case number that can appear in a column 312. For example, an original filing may be accorded a sub0case number of “00” while a first continuation of the original filing may be accorded a subcase number of “01”.

The government-assigned application number for each asset may appear in an application number column 314 and the related filing date can appear in a filing date column 316.

The status of each asset can be indicated in a status column 318. In the example shown, assuming patent assets, the status may be pending, abandoned, allowed, issued, etc. FIG. 3 illustrates a highlight 320 around the status “allowed” for the second asset listed in the title column 302. This reflects the operation in FIG. 4 at blocks 412-416, specifically, that a bullet date was received and the status of the second asset has changed from “pending” to “allowed” in the period between the bullet date (which may be inclusive of the bullet date) and a current date. The highlight may be effected by a box around the status as shown, or by coloring the status, or by bolding or underlining the status, or by an asterisk by the status, or by other means that visually and/or audible and/or tactilely distinguish the status from other listed but unchanged statuses for the other assets.

A patent number column 322 and issue date column 324 indicated the patent number and issue date, respectively, for each issued asset may also be presented.

It is to be understood that the information in the columns of FIG. 3 can be registered such that entries across columns for an asset appear in the same row or group of rows, to correlate the information in the columns with the respective titles in the first column 302.

Thus, FIGS. 2-4 provide a layout of data that is specific to a patent family. The layout may reflect a bullet report to visualize growth of a portfolio since a point in time the user specifies. The user inputs a bullet date, and the change in the portfolio status is highlighted since the bullet date. Thus, if a portfolio grows or changes during a business deal negotiation, the portfolio growth/change can be visualized during that time. Assets that are newly allowed, granted, or filed are shown clearly on report.

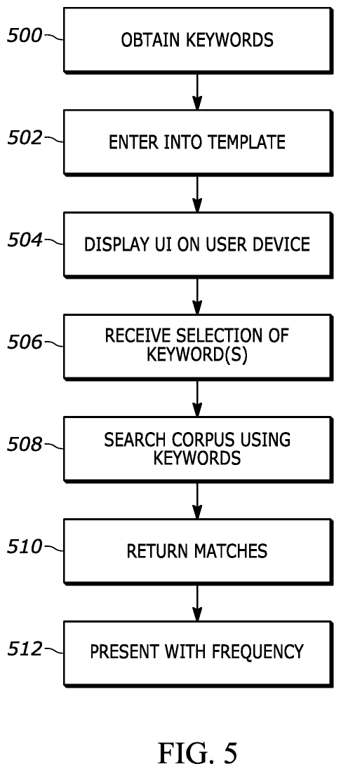

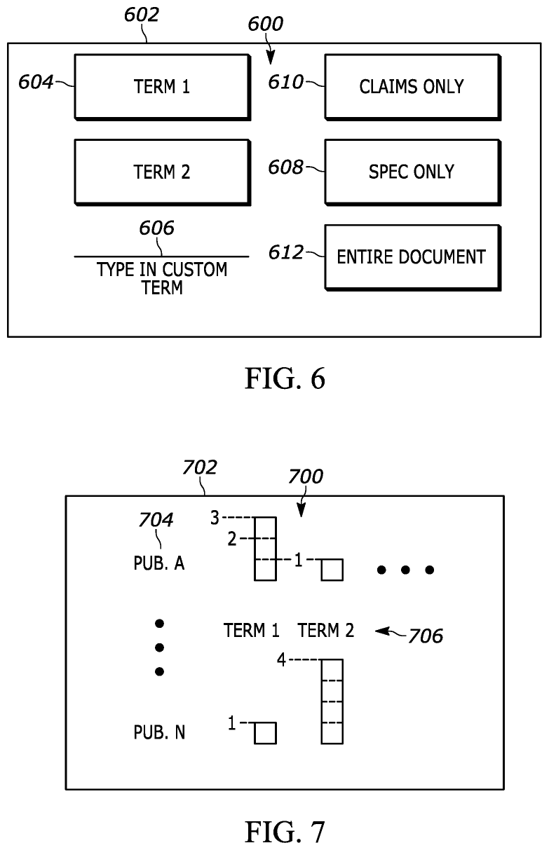

FIGS. 5-7 illustrate additional details for searching related intellectual asset (IA) records with data in a memory device of an intellectual asset management (IAM) server such as any of the servers described herein. Beginning at block 500 in FIG. 5, one or more keywords are obtained. At block 502 the keywords may be entered into an IA template object such as the object 600 presented on a display 602 in FIG. 6 consistent with block 504 of FIG. 5. The IA template object 600 is accessible from the IAM server via the computer network. The keywords from block 500 appear as “terms” 604 in FIG. 6 and each term may be instantiated by a selector. Also, a user can enter a custom keyword into a filed 606 in FIG. 6.

Proceeding from block 504 to block 506 in FIG. 5, one or more selections of the keyword selectors 604 in FIG. 6 corresponding to respective keywords is received. Moving to block 508, a computer a corpus of documents is searched using the keywords corresponding to the selections from the user device. The corpus may be the Web or a more limited corpus such as an acquisition target's publications.

Block 510 indicates that documents from the corpus are returned according to matching criteria of the keywords, i.e., documents are returned that match at least a threshold number of keywords or that include at least a threshold number of repetitions of one or more keywords, as but two examples, to thereby fingerprint the documents. The threshold numbers may be one or may be greater than one, and combinations of keywords and threshold numbers may be used. Ending at state 512, a results UI listing documents returned according to the matching criteria is presented on, e.g., any of the user devices described herein. The results UI may include information indicating, for each keyword matched in at least a first document, a frequency of match of the respective keyword, representing a fingerprint of the document.

Note that fingerprinting may be done only on a specification of a patent, and not the claims, or only on the claims of the patent, and not the specification, or on both the claims and specification of the patent, as desired. This is illustrated by the respective selectors 608, 610, 612 in FIG. 6.

FIG. 7 illustrates further. A results UI 700 may be presented on a display 702 of a user device. The results UI 700 may include a list 704 of publications satisfying the matching criteria. For each publication in the list, information 706 may be presented indicating, for each keyword matched in the corresponding document, a frequency of match of the respective keyword.

In the example shown, publications A-N have been returned, each satisfying matching criteria based on keywords “term 1” and “term 2”. The information 706 for each publication indicates, for each of the two keywords, a frequency of match of the keyword within the respective publication, in the example shown, in histogram format. Thus, for example, publication A has three matches for term 1 and one match for term 2, while publication N has one match for term 1 and four matches for term 2. Publications between A and N likewise are correlated with information pertaining to matches.

Thus, a template that has keywords can be provided. The template may be a list of many terms indicating things that make sense for a sector of interest such as “nanotechnology” and “static friction”. The technique in FIGS. 5-7 distills patent documents down and may present a histogram as to how many keyword matches a document contains. In this way, fingerprinting publications for a company being acquired is facilitated.

Thus, FIGS. 5-7 illustrate “asset fingerprinting” that outputs a “fingerprint” of the entire document or only a portion of the document as desired.

Templates may be made available by a service, a third party, or the user of the system. Templates can be purchased, modified, and keywords added or subtracted. Templates can be associated with a classification index of a patent office in any country.

In addition to specific templates where keywords are added to form the template, a universal template can be created based on the removal of non-technical or non-specific terms. Here a library of generic terms is used to remove from the document. After removal, the words that remain in the document (e.g., a patent specification) can be histogrammed to show the generic fingerprint. The library of words to remove may include but not be limited to words such as these and many more: the, a, and, of, this, that, because, with, from, into, related, etc. In other words, the elements that make up the library are words that are not technical or specific when taken alone.

Instead of matching keywords, a selector may be provided for the inverse, i.e., inputting words and then returning documents that do not match the keywords.

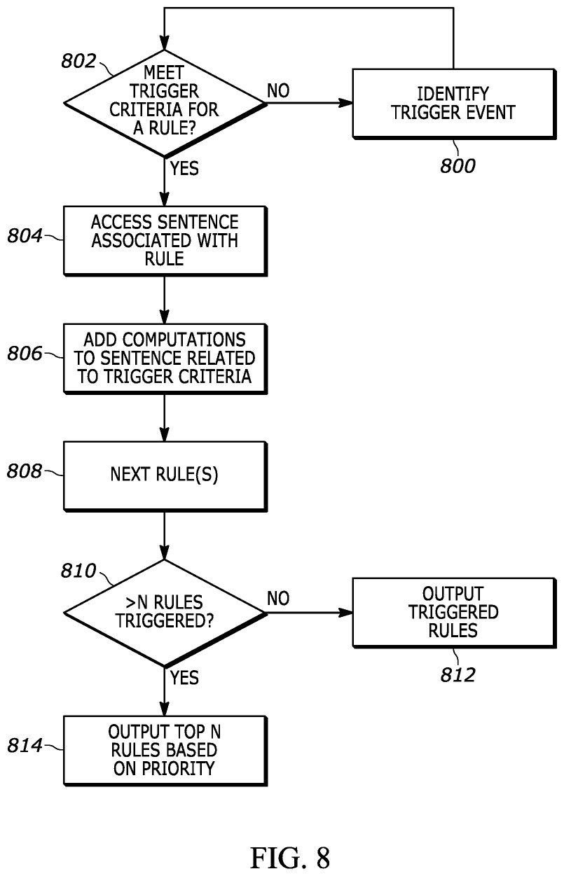

Turn now to FIGS. 8-10 for additional features. A technique is disclosed for generating a written “narrative” on a series of patent or other data to populate reports with a machine-generated discussion of portfolio activity.

Commencing at block 800 in FIG. 8, a trigger event is identified. A trigger event may be an event that possibly might trigger a rule. Examples of such events include additions to a patent report including entry of new filing data, entry of issuance data, a request for a report printout for activity since a threshold date, entry of other information described herein, and the elapse of threshold periods of time.

Decision diamond 802 indicates that it is determined whether the trigger event received at block 800 meets the criteria for invoking a rule that is associated with a comment or sentence. A comment may be a complete or incomplete sentence. Examples are given below. Essentially, a rule triggers based on computed metrics, in other words, the meeting of criteria for the rule based on variables calculated for a period of time associated with the report.

When a rule is triggered, the logic moves to block 804 at which a triggered rule results in identifying a comment or sentence associated with the rule for appending the comment or sentence to the report as a narrative. Block 806 indicates that the sentence itself may be augmented with additional computations in connection with the rule and generally based on the trigger event. The computations may be for the period of the report or may be a look back to compare the current period to previous periods or previous time frame to surface, for instance an interesting growth metric.

Block 808 indicates that the trigger event may apply to additional rules which are processed as described above in reference to states 802-806. Decision diamond 810 indicates that it may be determined whether more than a threshold (“N”) number of rules have been triggered by the event and if not, the sentences associated with the rules that were triggered, augmented by trigger-related computations, are output at block 812 for appending to a report as a narrative.

On the other hand, if more than the threshold number of rules are triggered, the logic may proceed to block 814 to output only a subset of the triggered rules based on, e.g., priority. That is, rules may be prioritized one over another to limit the total report narrative to “N” comments or sentences where one rule may supersede another if too many rules are triggered. The prioritization scheme may be fixed or may be dynamic to optimize for dynamic new things to surface each month.

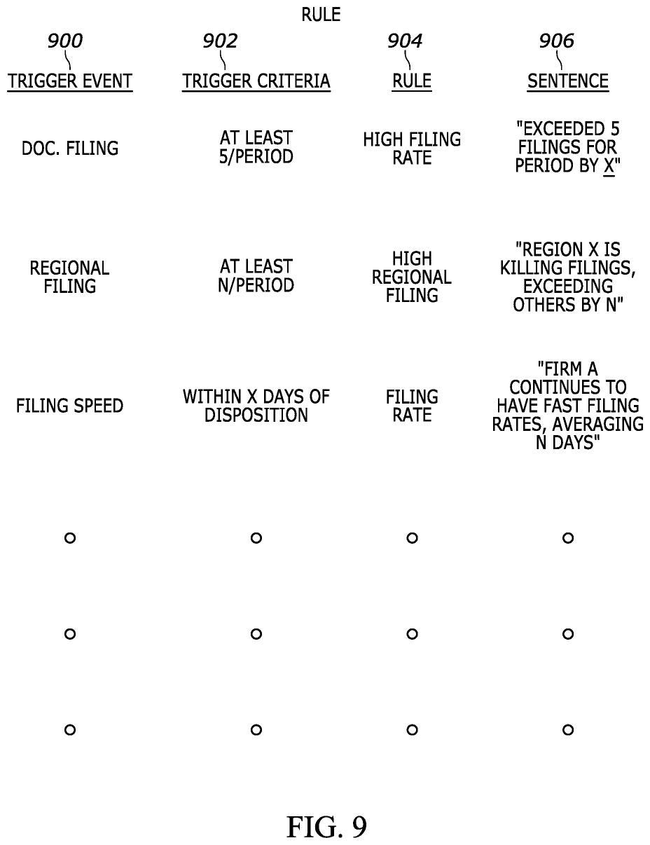

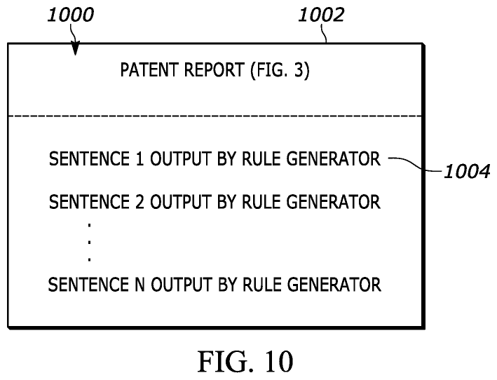

FIG. 9 illustrates examples of the technique shown in FIG. 8. Example non-limiting trigger events are shown in a first column 900, and example non-limiting trigger criteria are shown in a second column 902. Example non-limiting rule names are shown in a third column 904 and example non-limiting sentences or comments associated with each respective rule are shown in the last column 906.

As indicated in FIG. 9, a rule might surface exceptional or interesting facets of the portfolio, such as a burst above a threshold of filings in a category shown in the first row of FIG. 9. The example trigger event is the filing of a document with a Patent Office, and the trigger criteria is at least five such filings per period, e.g., one month. The rule if the criteria is met is “high filing rate”, and the comment associated with the rule is “exceeded five filings for the most recent period by X filings”, where five filings and the excess number represented by “X” are related to the trigger event and calculated by determining (1) that the criteria of five has been met, and (2) determining the number of filings in excess of five for the period under test.

Another example is shown in the second row in FIG. 9, illustrating a trigger event of a regional patent filing and trigger criteria of at least “N” such filings per period, wherein “N” is an integer, meaning the rule “high regional filing” examines whether one region is filing more or less number or percent than they typically (computed metric) do. The comment associated with the rule criteria being met may be “Region X is killing on filings, exceeding other regions by M” filings, where N filings and the excess number represented by “M” are related to the trigger event and calculated by determining (1) that the criteria of N has been met, and (2) determining the number of filings in excess of N for the period under test.

Yet another example is shown in the third row of FIG. 9, in which the trigger event is filing speed and the trigger criteria is within X days of having an invention disclosure disposed to patent counsel. The rule name might be “filing rate”, and the comment associated with the rule might be “Firm A continues to hold the leading position for quick turnaround time with application draft time of % computed % days” or “Firm A continue to have fast filing rates, averaging N days”, where the computations associated with the comment for appending to a report are based on trigger event and trigger criteria associated with the rule.

FIG. 10 illustrates a user interface (UI) 1000 that may be presented on a display 1002 such as any display described herein. A patent report such as the one shown in FIG. 3 may be presented, appended to which are various sentences or comments 1004 generated in accordance with the technique illustrated in FIGS. 8 and 9.

In some examples, an artificial intelligence-based classifier such as a neural network-based classifier creates rules automatically based on statistical anomalies. An example of such an anomaly is the emergence of an ad-hoc cluster of data, such as, for example, the emergence of a cluster of filings around a particular date. The system allows the operator to create a narrative sentence describing the emerging data cluster and when new activity is trending into the cluster, the sentence is added in the future.

So as another example, the AI classifier may identify that a particular jurisdiction is issuing patents relatively quickly, such as within six months of filing. The classifier may output this to a user, who can enter into a data entry field of a user interface (UI) a sentence such as “Country A is a good bet for a quick search and allowance”. Such a sentence may alternatively be generated by one or more neural networks comparing the issue time period of country A to other countries and constructing a sentence accordingly. For future observed performance in Country “A” or another country, the sentence can be automatically appended to a report with, e.g., an indicated average period between filing and issuance adjusted according to the new data.

It will be appreciated that whilst present principals have been described with reference to some example embodiments, these are not intended to be limiting, and that various alternative arrangements may be used to implement the subject matter claimed herein.

What is claimed is:

1. A method for creating a family of related records with common data in a memory device of at least one server, comprising:
causing, by the server, display of an object on a user device via a computer network;
obtaining, by the server, data for at least one current filing, at least a portion of the data being entered into the object, the data being communicated to the server via the computer network;
creating, by the server, a record in the memory device of the server for the current filing based on the obtained data;
causing, by the server, display of a user interface (UI) object on the user device via the computer network, the UI object including a parent title;
further obtaining, by the server, data for one or more related filings associated with the parent title, wherein the data includes record links between the current filing and the one or more related filings that indicate that the current filing and the related filings belong to a family of intellectual assets;
identifying, by the server, relationships between the current filing and the related filings, each of the relationships including one or more of a parent/child relationship, a foreign/domestic relationship, a continuation/parent relationship, a continuation-in-part/parent relationship, a nationalization relationship, a PCT/nationalization relationship, a PCT/priority relationship, or a provisional/non-provisional relationship;
determining respective statuses for the current filing and related filings;
receiving a bullet date;
identifying changes in the statuses since the bullet date; and
outputting a report highlighting the changes since the bullet date.

2. The method of claim 1, wherein the changes in statuses include changes as of the bullet date.

3. The method of claim 1, wherein the UI object comprises:
inventor information correlated with the parent title.

4. The method of claim 1, wherein the UI object comprises:
docket information correlated with the parent title.

5. The method of claim 1, wherein the UI object comprises:
country information correlated with the parent title.

6. The method of claim 1, wherein the UI object comprises:
sub-case information correlated with the parent title.

7. The method of claim 1, wherein the UI object comprises:
application number information correlated with the parent title.

8. The method of claim 1, wherein the UI object comprises:
filing date information correlated with the parent title.

9. The method of claim 1, wherein the UI object comprises:
status information correlated with the parent title.

10. The method of claim 1, wherein the UI object comprises:
patent date information correlated with the parent title.

11. The method of claim 1, wherein the UI object comprises:
patent number information correlated with the parent title.

12. The method of claim 1, comprising:
automatically adding to the report at least one comment responsive to a rule associated with the comment being triggered.

13. An apparatus comprising:
at least one processor programmed with instructions for searching related intellectual asset (IA) records with data in a memory device of an intellectual asset management (IAM) server, the processor programmed to:
obtain, by the IAM server, keywords;
enter the keywords into an IA template object, the IA template object being accessible from the IAM server via the computer network;
cause, by the IAM server, display of a template user interface (UI) on a user device consistent with the IA template, the template UI presenting selectors corresponding to respective keywords;
receive, from the user device, one or more selections of the selectors corresponding to respective keywords;
search using at least one computer a corpus of documents using the keywords corresponding to the selections from the user device;
return documents from the corpus according to matching criteria of the keywords; and
present on the user device a results UI listing documents returned according to the matching criteria, the results UI comprising information indicating, for each keyword matched in a first document, a frequency of match of the respective keyword.

14. The apparatus of claim 13, wherein the information indicates, for each keyword matched in a first document, a frequency of match of the respective keyword comprises a histogram.

15. An apparatus comprising:
at least one computer storage that is not a transitory signal and that comprises instructions executable by at least one processor for:
causing, by a server, display of an object on a user device via a computer network;
obtaining data for at least one current filing, at least a portion of the data being entered into the object, the data being communicated to the server via the computer network;
creating a record in the memory device of the server for the current filing based on the obtained data;
displaying a user interface (UI) on the user device via the computer network, the UI including a parent title;
obtaining data for one or more related filings associated with the parent title, wherein the data includes record links between the current filing and the one or more related filings that indicate that the current filing and the related filings belong to a family of intellectual assets;
identifying relationships between the current filing and the related filings, each of the relationships including one or more of a parent/child relationship, a foreign/domestic relationship, a continuation/parent relationship, a continuation-in-part/parent relationship, a nationalization relationship, a PCT/nationalization relationship, a PCT/priority relationship, or a provisional/non-provisional relationship;
determining respective statuses for the current filing and related filings;
receiving a bullet date;
identifying changes in the statuses since the bullet date; and
outputting a report highlighting the changes since the bullet date.

16. The apparatus of claim 15, wherein the instructions are executable for:
automatically adding to the report at least one comment responsive to a rule associated with the comment being triggered.

17. The apparatus of claim 15, wherein the changes in statuses include changes as of the bullet date.

18. The apparatus of claim 15, wherein the UI comprises:
inventor information correlated with the parent title.

19. The apparatus of claim 15, wherein the UI comprises:
docket information correlated with the parent title.

20. The apparatus of claim 15, comprising the at least one processor.
